(19) United States
(12) Patent Application Publication
(10) Pub. No.: US 2024/0057616 A1
(43) Pub. Date: Feb. 22, 2024

(54) ARTHROPOD REPELLENT AND PROCEDURES

(71) Applicant: Bonnie Carol Minsky, Lake Forest, IL (US)

(72) Inventor: Bonnie Carol Minsky, Lake Forest, IL (US)

(21) Appl. No.: 18/445,371

(22) Filed: Aug. 3, 2023

Related U.S. Application Data
(60) Provisional application No. 63/474,531, filed on Aug. 22, 2022.

(51) Int. Cl. A01N 65/12; A01N 65/36; A01P 17/00

(52) U.S. Cl. CPC A01N 65/12; A01N 65/36; A01P 17/00

(57) ABSTRACT

A repellent for arthropods, such as biting midges and other insects, is simple yet effective when applied to a mammal's skin or hide, and is produced and employed by uncomplicated methods. The repellent utilizes only three active ingredients, Marigold extract, alcohol, and zinc (or as a fourth active ingredient grapefruit seed extract). The Marigold extract is desirably produced using leaves and flowers of organic Tagetes erecta or Tegestes minuta. The alcohol is desirably medical grade isopropyl alcohol, the zinc is desirably in the form of liquid nano-particles, and the grapefruit seed extract is also in liquid form. Inactive ingredients such as peppermint oil may also be included.

### CROSS-REFERENCE TO RELATED APPLICATION

This application claims priority of U.S. Provisional Application Ser. 63/474,531 filed Aug. 22, 2022, the disclosure of which is incorporated by reference herein.

### BACKGROUND AND SUMMARY OF THE INVENTION

Biting insects and other arthropods, especially blood feeding arthropods of the Order Diptera such as the Family (Ceratopogonidae) of flies commonly known as no-see-urns or biting midges, are a significant nuisance to humans and domesticated animals. Complex chemicals, such as shown in U.S. Pat. Nos. 5,792,467, 6,660,775, 9,924,718, and 10,842,726, are sometimes used to repel such invertebrates. Some natural repellents such as extracts of lavender, Eucalyptus (e.g. lemon Eucalyptus), coleus, or citronella and mixtures thereof have also been used with widely varying degrees of effectiveness (see Repellent, Irritant and Toxic Effects of 20 Plant Extracts on Adults of the Malaria Vector Anopheles gambiae Mosquito, by Deletre et al, PLOS One, December, 2013). Many of the repellents that have some success also can have adverse environmental effects or irritating qualities, and some popular chemical repellents such as DEET can cause health issues.

According to the invention an effective arthropod repellent, and procedures for using and making the repellent, are provided that cause no significant harm to the environment and with no to minimal capability to cause irritation to humans using the repellent. When applied to skin (or sometimes clothing though likely not as effective) the composition performs very well as a repellent and in addition when applied after some arthropod bites, such as from biting midges, acts to relieve itching and irritation. The composition of the invention is also extremely simple despite its effectiveness and can consist essentially of only four active ingredients.

The simplicity of the invention should be compared with other representative commercial and patented products. For example one popular commercial insect repellent (“Liquid Net™”) represented as being for mosquitoes, gnats, ticks, no-see-ums, and other biting insects, contains seven active ingredients (citronella, cedarwood, lemon-grass oil, geraniol, sodium lauryl sulfate, peppermint, and eugenol) and three inactive ingredients (water, lime, and wintergreen). Another popular commercial insect repellent (“West a-Nile-Ate™”) contains hempseed oil, aloe vera, wheatgerm oil, avocado oil, grapeseed oil, and a secret blend of steam distilled essential oils. Similarly the mosquito repellent of CN105875669 contains eight active ingredients (Chrysanthemum cinerarifolium, marigold, orange peel, folium artemisiae argyi, geranium, grapefruit essential oil, lavender, and ethanol) as well as deionized water. Ensuring the availability of such a significant number of components can be a strain on the supply chain as well as complicating production, which are meaningfully avoided according to the invention.

The most basic ingredient of the repellent of the invention is an extract of Marigold (Genus Tagetes) which has a fairly large number of species probably all of which (certainly Tegetes Erecta and Tegestes minuta) are known to have at least limonene and epoxyocimene (aka (E)-ocimenone; see NIST Chemistry WebBook, SRD69) which even alone are at least somewhat effective in deterring pests in gardens (see https://www.featherinthewoods.com/2017/07/how-to-make-marigold-bug-spray.html; Repellent . . . , supra; “A brief review on medicinal plant Tagetes erecta Linn”, Shetty et al, Journal of Applied Pharmaceutical Science Vol. 5, 2015; “Chemical composition, . . . of Tagetes minuta and Ocimum basilicum essential oils,” Shirazi et al, Food Science & Nutrition, 2014; and “Methanol Extract Lotion of Tegetes erecdta L Flower as A Repellent . . . ”, Maisaroh et al, Universitas Muhammadiyah Yogyakarta, Indonesia, Aug. 25-26, 2021).

All ingredients of the repellent of the invention are natural, and at least the Marigold is desirably organic. The only four active ingredients are the previously mentioned Marigold extract, isopropyl alcohol, zinc, and a natural ingredient (such as grapefruit seed extract) which helps prevent the itching, redness, and/or swelling that midge bites typically cause. Other, inactive, ingredients may be provided such as wintergreen extract to mask the smell of the alcohol if that smell is considered undesirable, and also to give a cooling sensation if there is irritation of the user's skin, and/or peppermint oil.

The Marigold used to make the Marigold extract is preferably the most pungent Marigold available, such as organic Mexican Marigold (Tagetes Erecta) or African Marigold (Tegestes minuta); flowers and leaves can be used and even stems, although less desirable than flowers and leaves. The isopropyl alcohol is preferably medical grade. The zinc is preferably in the form of liquid crystalline zinc Nano-particles such as commercially available as NutriNoche Pure Crystalline Liquid Zinc. The grapefruit seed extract may be Nutribiotic Grapefruit Seed Extract Liquid Concentrate, which is free of synthetic chemicals and is mixed with vegetable glycerin and which is primarily made from the pulp, seeds, and white membranes of grapefruit. If used the peppermint oil may be NOW Brand 100% pure peppermint oil, and the herbal wintergreen liquid extract may be Hawaii Pharm Wintergreen Alcohol-Free Liquid Extract made with wild harvested wintergreen dried leaf powder, which also includes crystal clear water and vegetable palm glycerin.

The zinc nano-particles are absorbed by the user's skin at a cellular level and along with the natural repellent action of the Marigold is an effective repellent. The isopropyl alcohol in addition to reacting with the Marigold constituents to produce the Marigold extract also assists in healing of the user's skin, and the grapefruit seed extract or the like helps prevent the itching, redness, and/or swelling that midge bits typically cause.

In one exemplary manner of producing the repellent according to the invention a sealable container is filled with Marigold leaves and flowers. The Marigold constituents are covered with medical grade isopropyl alcohol and the container is sealed and left standing, preferably at approximately ambient temperature (if over about 60° F.), for at least about 24 hours, desirably between about 24-72 hours, producing a Marigold extract in alcohol. The Marigold extract in alcohol is filtered using any conventional technique (such as filter paper) to remove large particles and the liquid filtrate produced is deposited in a second container. The liquid zinc—and if used the grapefruit seed extract and inactive ingredients—are added to the Marigold extract and alcohol in the second container to produce the final repellent liquid. The final repellent liquid is then preferably moved into a conventional spray bottle (manual or aerosol) and is sprayed onto a user's skin prior to exposure to biting midges, or other blood feeding arthropods of the Order Diptera.

According to one aspect of the present invention a repellant for blood feeding arthropods of the Order Diptera comprises, or consists essentially of, as active ingredients Marigold extract, alcohol, and zinc. According to another aspect of the present invention a repellant for blood feeding arthropods of the Order Diptera comprises, or consists essentially of, as active ingredients the previously mentioned one as well as a minor amount of another ingredient that helps prevent the itching, redness, and/or swelling that midge bites typically cause, preferably grapefruit seed extract. The Marigold extract is preferably obtained from Mexican Marigold Tagetes Erecta or African Marigold Tegestes minuta (most desirably organic); the alcohol is preferably isopropyl alcohol (most desirably medical grade); and the zinc is preferably in the form of a liquid of zinc nano-particles. Other inactive ingredients may also be provided.

According to another aspect of the invention there is provided a method of repelling and deterring landing on mammals by blood feeding arthropods of the Order Diptera, the method comprising: a) applying an effective amount of a liquid repellent comprising as active ingredients Marigold extract, isopropyl alcohol, and liquid zinc to the skin or hide of a mammal. The procedure a) preferably also includes as an active ingredient grapefruit seed extract and is preferably practiced by spraying. Additionally a) may be further practiced by providing the liquid repellent with inactive ingredients comprising at least one of wintergreen and peppermint oil, and a) is further practiced before exposing the mammal to no-see-urns.

According to another aspect of the invention there is provided a conventional spray bottle containing a liquid insect repellent comprising, or consisting of, Marigold extract, isopropyl alcohol, and liquid zinc nano-particles as active ingredients, and preferably also grapefruit seed extract or the like.

According to yet another aspect of the present invention there is provided a method of making a liquid repellent for biting insects comprising: a) putting Marigold leaves and flowers into a first container; b) pouring isopropyl alcohol over the Marigold leaves and flowers to cover the leaves and flowers; c) substantially sealing the first container and letting the components sit for an effective period of time; d) after the passage of the effective period of time filtering the components of the first container to remove particles larger than a particular size (so that they won't clog a spraying device, such as a manual spray bottle, when the liquid is subsequently introduced into a spraying device) to provide a filtrate; e) putting the filtrate into a second container; and f) adding liquid zinc and preferably grapefruit seed extract and any desired inactive ingredients to the second container to produce a final biting insect repellent.

In the method of the preceding paragraph c) is preferably practiced for a time period of about 24-72 hours at substantially ambient temperature. Also the method may further comprise, g) reducing the size of the Marigold leaves and flowers before practicing a). Most desirably f) is practiced using liquid zinc nano-particles. In the practice of the method the ratio of Marigold flowers and leaves to isopropyl alcohol to liquid zinc nano-particles and if used grapefruit seed extract is preferably about 7-14 parts, to 7-14 parts, to less than one part, to less than one part, respectively, and if used the inactive ingredients are also significantly less than one part.

It is the primary object of the invention to provide an effective way to prevent biting by no-see-ums or the like, and/or any itch that may result, by providing a suitable repellant and method of making and using it. This and other objects of the invention will become clear from a detailed description of the invention, and from the appended claims.

### DETAILED DESCRIPTION OF THE INVENTION

In its most basic form a simple yet effective repellant for blood feeding arthropods of the Order Diptera is provided. The repellent comprises, consists of, or consists essentially of, Marigold extract, alcohol, and zinc as active ingredients. A fourth active ingredient is also desirable that helps prevent the itching, redness, and/or swelling that midge bites typically cause, the fourth ingredient preferably grapefruit seed extract. The Marigold extract is preferably obtained from the flowers and leaves of Tagetes Erecta or Tegestes minuta (most desirably organic), although stems can be used in some circumstances. The alcohol is preferably isopropyl alcohol (most desirably medical grade). The zinc is preferably in a liquid form, most effectively in the form of a liquid of zinc nano-particles. The grapefruit seed extract is also in liquid form and also has the advantage of having anti-fungal and anti-bacterial properties. The repellent can include at least one of wintergreen and peppermint oil as inactive ingredients although other inactive ingredients may be provided in place of, or in addition thereto. The repellent may be provided in, and applied by, a conventional spray bottle, either manual or pressurized, or a similar conventional applicator.

There is also provided a method of repelling and deterring landing on mammals by blood feeding arthropods of the Order Diptera. The method may comprise: a) applying an effective amount of a liquid repellent comprising as active ingredients Marigold extract, isopropyl alcohol, and liquid zinc, and preferably grapefruit seed extract, to the skin or hide of a mammal. The procedure a) is preferably practiced by spraying. Additionally a) may be further practiced by providing the liquid repellent with inactive ingredients, and a) is further preferably practiced before exposing the mammal to no-see-urns.

Herein there is also provided a method of making a liquid repellent for biting insects comprising: a) putting Marigold leaves and flowers into a first container; b) pouring isopropyl alcohol over the Marigold leaves and flowers to cover the leaves and flowers; c) substantially sealing the first container and letting the components sit for an effective period of time; d) after the passage of the effective period of time filtering the components of the first container to remove particles larger than a particular size (to prevent clogging of a sprayer) to provide a filtrate; e) putting the filtrate into a second container; and f) adding liquid zinc and preferably grapefruit seed extract, any desired inactive ingredients, to the second container to produce a final biting insect repellent.

In the method of the preceding paragraph c) is preferably practiced for a time period of about 24-72 hours at substantially ambient temperature [at least about 60° F., preferably at room temperature (about 68-74° F.), although it can be heated as long as below the temperature where the components are adversely affected]. Also the method may further comprise, g) reducing the size of the Marigold leaves and flowers before practicing a). Most desirably f) is practiced using liquid zinc nano-particles. In the practice of the method the ratio of Marigold flowers and leaves to isopropyl alcohol is preferably about 7-14 parts to about 7-14 parts, and the ratio to zinc and grapefruit seed extract is in each case significantly less than one part. Stems can sometimes be used with flowers and leaves, and the Marigold is preferably organic and since they typically are the most pungent types of Marigold, of Tagetes Erecta or Tegestes minuta.

### EXAMPLE I

About seven ounces by weight of Tagetes Erecta Marigold flowers and leaves are added to a sealable container, and about nine ounces liquid Belle Chemical Medical Grade Isopropyl Alcohol is poured over the Marigold flowers and leaves. The container is sealed and the constituents are left standing at about 70-80° F. for about thirty six hours, producing a Marigold extract in alcohol. The Marigold extract and alcohol liquid is filtered using a suitable commercial filter paper, such as 20-150 μm pore size filter paper, to filter out large particles and the filtrate is placed in a second container. In the second container about one liquid ounce of NutriNoche Pure Crystalline Liquid Zinc in the form of nano-particles is added to the filtrate, and if desired about 4 ml of grapefruit seed extract. After hand stirring with a spatula the resulting repellent liquid is placed in a conventional manual spray bottle. The bare ankles of a human are sprayed with the repellent liquid covering substantially the entire exposed skin. After exposure to no-see-urns for fifteen minutes no significant evidence of Ceratopogonidae bites was visible to the naked eye.

### EXAMPLE II

About 12 ounces by weight organic orange and yellow Mexican marigold flowers, and leaves, were placed into a 24 oz. mason jar with a tight lid. Then about 12 liquid ounces of 99% Belle Chemical medical grade isopropyl alcohol was poured over the flowers and leaves, enough to fill the jar, the lid was sealed, and the components were left to infuse at ambient temperature (roughly about 72° F.) for approximately 48 hours. The infusion was then strained into two smaller (12 oz.) mason jars using No. 4 all natural brown cone coffee filters to strain out particles and produce a filtrate. About 40 mg of liquid NutriNoche Pure Crystalline Liquid Zinc in the form of nano-particles was added to each of the two jars, and about 100 mg of grapefruit seed extract was added to each jar. The final mixtures from the two jars were poured into 3.2 ounce hard (no BPA) clear plastic manual spray bottles, about 2 oz. in each spray bottle.

### Test Report

In actual field tests in Florida and Texas, where no-see-urns are particularly prevalent, the effectiveness of the repellent and methods of the invention were proven. Each of twenty five people, none of whom had any economic interest in the invention, anonymously reported their results. Each was provided with a 3.2 ounce spray bottle with about two ounces of a repellent liquid according to the invention prepared as set forth in Example II above. The repellent included about twelve parts organic Tagetes Erecta Marigold flowers and leaves, about twelve parts medical grade isopropyl alcohol, and less than one part liquid zinc nano-particles, and less than one part grapeseed extract. Each participant was requested to first go to an area where no-see-ums were believed common, anonymously report the results, and then after a period of one to several days return to the same approximate area after application of the repellent described above and again anonymously report the results.

The results were reported anonymously by twenty five individuals in Florida or Texas. The ages of the participants ranged from 13 to 81 (and all decades in that range were represented by at least three individuals except the 80s), 14 were male, and 11 were female. All of the individuals reported significant to severe redness and itching (and most swelling) after exposure to no-see-urns before application of the repellent of the invention. After spray application of the repellent 11 reported no bites, itching, or swelling whatsoever, 12 reported only tiny red dots after exposure and no itching or swelling whatsoever, and two (a 13 year old female and a 36 year old female) reported slight bites and itching and that the itching promptly went away after a second application of the repellent of the invention.

While it is not usually necessary in order to produce an effective Marigold extract, if desired the Marigold leaves and flowers (and stems if utilized) may be subjected to any conventional procedure to reduce the size of the components before treatment with alcohol, such as manual or automatic chopping, milling, shredding, grinding, or the like. Also while treatment at ambient temperatures of at least about 60° F. is effective if desired the Marigold-alcohol mix may be heated by any conventional means to temperatures significantly less than the boiling point of the alcohol (e. g. to a temperature of about 90-150° F.).

Only small amounts of liquid zinc and grapefruit seed extract are necessary when combined with major parts of marigold extract and alcohol to get desired results. For example anywhere between about 20-100 mg (preferably about 35-50 mg) of liquid zinc per 12 oz. of a combination of marigold extract and alcohol can be effective and anywhere between about 75-250 mg. (preferably about 90-150 mg) of grapefruit seed extract per 12 oz. of a combination of marigold extract and alcohol can be effective. While larger amounts of zinc and grapefruit seed extract can be used, more than set forth is clearly wasted and not economical.

While the invention has been herein shown and described in what is presently conceived to be the most practical and preferred embodiment thereof it is to be understood that the invention should be interpreted to cover all equivalent repellents and methods of use and manufacture thereof limited only by the prior art and the appended claims. It is also to be understood that all ranges set forth specifically include all individual ranges within a broad range.

What is claimed is:

1. A repellent for blood feeding arthropods of the Order Diptera comprising as active ingredients Marigold extract, alcohol, and zinc.

2. A repellent as recited in claim 1 also comprising as an active ingredient grapefruit seed extract

3. A repellent as recited in claim 2 wherein the ingredients consist essentially of Marigold extract, alcohol, zinc, and grapefruit seed extract.

4. A repellent as recited in claim 2 wherein the repellent includes about seven-fourteen parts each Marigold extract and alcohol and less than one part each zinc and grapefruit seed extract.

5. A repellent as recited in claim 1 wherein the Marigold extract is obtained from Tagetes erecta or Tegestes minuta; wherein the alcohol is isopropyl alcohol; and wherein the zinc is in the form of a liquid of zinc nano-particles.

6. A repellent as recited claim 5 wherein the repellent active ingredients consist of Marigold extract, isopropyl alcohol, liquid zinc particles, and also a minor part ingredient that helps prevent the itching, redness, and/or swelling that arthropod bites typically cause.

7. A repellent as recited in claim 6 wherein the minor part ingredient that helps prevent the itching, redness, and/or swelling comprises grapefruit seed extract; and wherein about 35-50 mg of liquid zinc and about 90-150 mg of grapefruit seed extract are provided per 12 oz. of combined marigold extract and isopropyl alcohol.

8. A repellent as recited in claim 3 wherein the Marigold extract is obtained from organic Tagetes erecta or Tegestes minuta; wherein the alcohol is medical grade isopropyl alcohol; and wherein the zinc is in the form of a liquid of zinc nano-particles.

9. A repellent as recited in claim 2 provided in a conventional manual or pressurized spray bottle.

10. A method of repelling and deterring landing on a mammal by blood feeding arthropods of the Order Diptera, the method comprising: a) applying an effective amount of a liquid repellent comprising as active ingredients Marigold extract, isopropyl alcohol, and liquid zinc to the skin or hide of a mammal.

11. A method as recited in claim 10 wherein a) is practiced by spraying.

12. A method as recited in claim 10 wherein a) is further practiced by providing the liquid repellent with a minor part of grapefruit seed extract as an active ingredient and wherein the repellent consists essentially of Marigold extract, isopropyl alcohol, liquid zinc, and liquid grapefruit seed extract.

13. A method as recited in claim 12 wherein a) is further practiced before exposing the mammal to no-see-ums.

14. A method as recited in claim 12 wherein the liquid repellent applied in a) comprises about 7-14 parts Marigold extract, about 7-14 parts isopropyl alcohol, and less than one part of each of liquid zinc nano-particles and liquid grapefruit seed extract.

15. A method of making a liquid repellent for biting insects comprising:
a) putting Marigold leaves and flowers into a first container;
b) pouring isopropyl alcohol over the Marigold leaves and flowers to cover the leaves and flowers;
c) substantially sealing the first container and letting the components sit for an effective period of time;
d) after the passage of the effective period of time filtering the components of the first container to remove particles larger than a particular size to provide a filtrate;
e) putting the filtrate into a second container; and
f) adding liquid zinc and any desired inactive ingredients to the second container to produce a final biting insect repellent.

16. A method as recited in claim 15 wherein f) is further practiced by adding as a fourth active ingredient liquid grapefruit seed extract, and wherein the final biting insect repellent consists essentially of Marigold extract, alcohol, zinc, and grapefruit seed extract.

17. A method as recited in claim 15 wherein c) is practiced for a time period of about 24-72 hours at substantially ambient temperature.

18. A method as recited in claim 16 further comprising, g) reducing the size of the Marigold leaves and flowers before practicing a).

19. A method as recited in claim 15 wherein f) is practiced using liquid zinc nano-particles.

20. A method as recited in claim 16 wherein a) is practiced by using organic Tagetes erecta or Tegestes minuta Marigold and medical grade isopropyl alcohol; and wherein f) is practiced using a liquid of zinc nano-particles liquid grapefruit seed extract.
